(19) United States
(12) Patent Application Publication
(10) Pub. No.: US 2016/0352207 A1
(43) Pub. Date: Dec. 1, 2016

(54) ELASTIC MEMBER IN VOICE COIL MOTOR AND ELECTRONIC DEVICE USING THE SAME

(71) Applicant: HON HAI PRECISION INDUSTRY CO., LTD., New Taipei (TW)

(72) Inventor: CHENG-SHIUN WU, New Taipei (TW)

(21) Appl. No.: 14/819,624

(22) Filed: Aug. 6, 2015

(30) Foreign Application Priority Data
May 28, 2015 (TW) 104117252

(51) Int. Cl. H02K 41/035; F16F 1/18

(52) U.S. Cl. CPC H02K 41/0356; F16F 1/187

(57) ABSTRACT

An elastic member in a voice coil motor includes a first member, a second member connected with the first member, and a slit defined between the first member and the second member. An elastic portion is located in the slit and connected with the first member and the second member. The elastic portion includes at least one elastic plate, and at least one elastic arm secured to the elastic plate. A voice coil motor using the elastic member and an electronic device using the voice coil motor are also provided.

### FIELD

The subject matter generally relates to voice coil motors.

### BACKGROUND

Voice coil motors can be mounted in camera modules for moving lenses. A voice coil motor usually includes a coil, at least one magnet, and at least one elastic member. The coil generates a magnetic field after being energized, and moves the lens mounted in the coil. The elastic member is secured to the coil, and serves as a resilient element to return the coil to its original position when the coil is not energized.

### BRIEF DESCRIPTION OF THE DRAWINGS

Implementations of the present technology will now be described, by way of example only, with reference to the attached figures.

FIG. 1 is an plan view of an elastic member according to the present disclosure.

FIG. 2 is an exploded, isometric view of a voice coil motor using the elastic member of FIG. 1.

FIG. 3 is an isometric view of an electronic device using the voice coil motor of FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like.

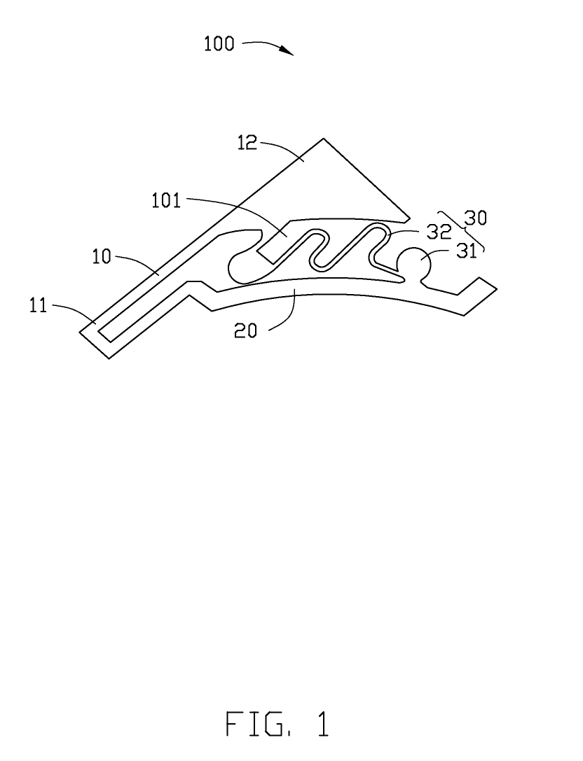

FIG. 1 illustrates an embodiment of an elastic member 100 including a first member 10 and a second member 20 connected with at least one end of the first member 10. A slit 101 is defined between the first member 10 and the second member 20. An elastic portion 30 is located in the slit 101 and connected with the first member 10 and the second member 20. The elastic portion 30 includes at least one elastic plate 31, and at least one elastic arm 32 secured to the elastic plate 31. The first member 10, the second member 20, and the elastic portion 30 are substantially in a plane when in an unstressed state.

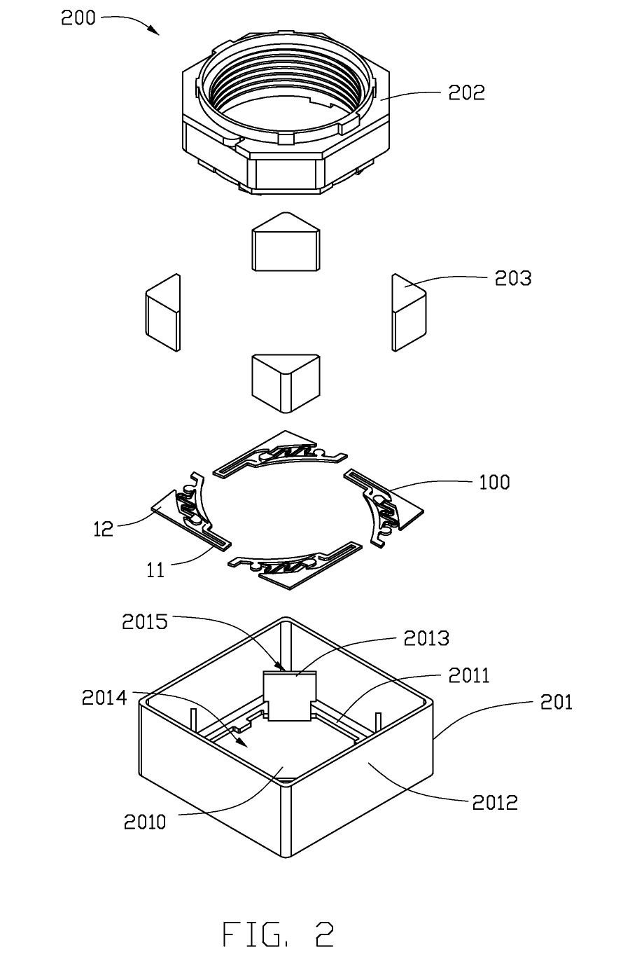

The elastic plate 31 is wider than the elastic arm 32, and has a rigidity greater than that of the elastic arm 32. As such, the elastic plate 31 has an elasticity coefficient k larger than that of the elastic arm 32. According to the Hooke's law: F=k*ΔX (wherein, F denotes an external force applied to an object and ΔX denotes a deformation of the object), when an external force F is applied to the elastic member 100, the greater the elasticity coefficient k of the elastic plate 31, the less the amount of deformation ΔX of the elastic portion 30. As such, when the first member 10 is fixed, for example, to a voice coil motor 200 (shown in FIG. 2), an amount of movement of the second member 20 is small relative to that of the first member 10. A size of the elastic plate 31 can be varied to adjust the rigidity thereof. The greater the rigidity of the elastic plate 31, the greater the size of the elastic plate 31. The elastic plate 31 may be circular or polygonal.

The elastic arm 32 is curved. In this embodiment, the elastic 32 is substantially M-shaped. In another embodiment, the shape of the elastic arm 32 may be different.

In this embodiment, the second member 20 is arched toward the first member 10. The first member 10 includes a first end portion 11 connected with the second member 20, and a second end portion 12 opposite to the first end portion 11. The width of the first member 10 increases gradually from the first end portion 11 to the second end portion 12. That is, the second end portion 12 has the larger size. In at least one embodiment, the second end portion 12 is made of elastic material which can be elastically deformed, thereby causing the second end portion 12 to have a greater elasticity coefficient k. As such, when an external force F is exerted on the elastic member 100, the second end portion 12 has deformation ΔX, thereby the amount of movement of the second member 20 is small relative to that of the first member 10.

In this embodiment, the elastic portion 30 includes two elastic plates 31 and only one elastic arm 32. The two elastic plates 31 are secured to the first member 10 and second member 20, and are adjacent to two ends of the second member 20. The elastic arm 32 is secured between the two elastic plates 31. In another embodiment, the number of the elastic plates 31 and the elastic arms 32 may be varied, and the elastic plate 31 and the elastic arm 32 may be secured to each other.

FIG. 2 illustrates an embodiment of a voice coil motor 200 including a hollow housing 201, a movable member 202, and a number of magnets 203 movably received in the housing 201. A number of elastic members 100 are secured to the housing 201. The movable member 202 can receive a lens (not shown). The number of magnets 203 is equal to the number of the elastic members 100.

The housing 201 includes a number of sidewalls 2012 and a top plate 2011 extending from the sidewalls 2012. The four sidewalls 2012 are connected with each other to form interior corners 2015. The top plate 2011 is substantially perpendicular to the sidewalls 2012, and defines a central aperture 2014. The sidewalls 2012 and the top plate 2011 cooperatively define a receiving space 2010. The housing 201 further includes a number of tabs 2013 extending inwardly from a rim of the aperture 2014 into the receiving space 2010. The magnets 203, which are triangular in cross section, are attached to the corners 2015 and face the tabs 2013. Each elastic member 100 is received in a receiving space 2010, with the second end portion 12 being fixed to one corner 2015 by adhesive. The second end portion 12 of the first member 10 of each elastic member 100 is sandwiched and fixed between the top plate 2011 and one magnet 203, and the second member 20 of the elastic member 100 is secured to the movable member 20 or to the lens received in the movable member 202. The movable member 202 is movably received in the receiving space 2010. The elastic members 100 are located between the movable member 202 and sidewalls 2012.

When the voice coil motor 200 is vibrated (for example, when the voice coil motor 200 is dropped on ground, or is implementing an auto-focus process), the movable member 202 moves the lens, thereby causing the second member 20 of each elastic member 100 and the elastic portion 30 secured to the second member 20 to move relative to the first member 10, being thus elastically deformed. Since each of the first member 10 is fixed between the top plate 2011 and one magnet 203, the second member 20 and the elastic portion 30 are then in different planes. Furthermore, since each of the first member 10 and the elastic plate 31 have great rigidity, the second member 20 suffers a small amount of deformation and a small amount of movement relative to the first member 10. That is, the elastic member 100 has a small amount of deformation.

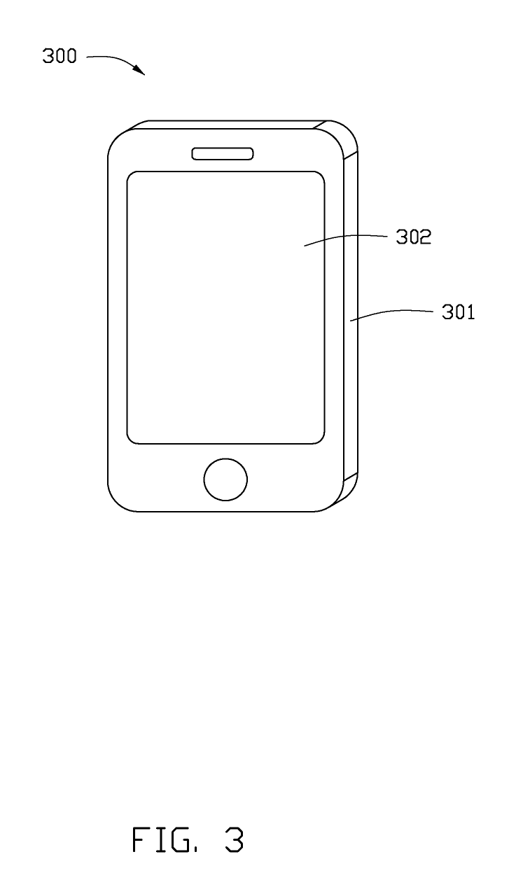

FIG. 3 illustrates an embodiment of an electronic device 300 including the voice coil motor 200. The electronic device 300 further includes a casing 301, and a display screen 302 secured to the casing 301. The casing 301 and the display screen 302 cooperatively define a cavity (not shown). The voice coil motor 200 is fixedly received in the cavity. The electronic device 300 can be a cell phone, a table computer, or a camera.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including in matters of shape, size, and arrangement of the parts within the principles of the present disclosure, up to and including, the full extent established by the broad general meaning of the terms used in the claims.

What is claimed is:

1. An elastic member comprising:
a first member;
a second member connected with the first member;
a slit defined between the first member and the second member; and
an elastic portion located in the slit and connected with the first member and the second member, the elastic portion comprising:
at least one elastic plate; and
at least one elastic arm secured to the at least one elastic plate.

2. The elastic member of claim 1, wherein the elastic plate is wider than the elastic arm, and has a rigidity greater than that of the elastic arm.

3. The elastic member of claim 1, wherein the elastic plate is substantially circular or polygonal; the elastic arm is curved.

4. The elastic member of claim 1, wherein the elastic portion comprises two elastic plates and only one elastic arm; the two elastic plates are secured to the first member and second member, and are adjacent to two ends of the second member; the elastic arm is secured between the two elastic plates.

5. The elastic member of claim 1, wherein the first member comprises a first end portion connected with the second member, and a second end portion opposite to the first end portion; a width of the first member increases gradually from the first end portion to the second end portion.

6. The elastic member of claim 5, wherein the second member is arched toward the first member.

7. A voice coil motor comprising:
a housing;
a movable member movably received in the housing; and
a plurality of elastic members received in the housing, each of the plurality of elastic member comprising:
a first member fixedly secured in the housing;
a second member connected with the first member and the movable member;
a slit defined between the first member and the second member; and
an elastic portion located in the slit and connected with the first member and the second member, the elastic portion comprising:
at least one elastic plate; and
at least one elastic arm secured to the at least one elastic plate.

8. The voice coil motor of claim 7, wherein the elastic plate is wider than the elastic arm, and has a rigidity greater than that of the elastic arm.

9. The voice coil motor of claim 7, wherein the elastic plate substantially circular or polygonal; the elastic arm is curved.

10. The voice coil motor of claim 7, wherein the elastic portion comprises two elastic plates and only one elastic arm; the two elastic plates are secured to the first member and second member, and are adjacent to two ends of the second member; the elastic arm is secured between the two elastic plates.

11. The voice coil motor of claim 7, wherein the first member comprises a first end portion connected with the second member, and a second end portion opposite to the first end portion; a width of the first member increases gradually from the first end portion to the second end portion.

12. The voice coil motor of claim 11, wherein the second member is arched toward the first member.

13. An electronic device comprising:
a voice coil motor comprising:
a housing;
a movable member movably received in the housing; and
a plurality of elastic members received in the housing, each of the plurality of elastic member comprising:
a first member fixedly secured in the housing;
a second member connected with the first member and the movable member;
a slit defined between the first member and the second member; and
an elastic portion located in the slit and connected with the first member and the second member, the elastic portion comprising:
at least one elastic plate; and
at least one elastic arm secured to the at least one elastic plate.

14. The electronic device of claim 13, wherein the elastic plate is wider than the elastic arm, and has a rigidity greater than that of the elastic arm.

15. The electronic device of claim 13, wherein the elastic plate is substantially circular or polygonal; the elastic arm is curved.

16. The electronic device of claim 13, wherein the elastic portion comprises two elastic plates and only one elastic arm; the two elastic plates are secured to the first member and second member, and are adjacent to two ends of the second member; the elastic arm is secured between the two elastic plates.

17. The electronic device of claim 13, wherein the first member comprises a first end portion connected with the second member, and a second end portion opposite to the first end portion; a width of the first member increases gradually from the first end portion to the second end portion.

18. The electronic device of claim 17, wherein the second member is arched toward the first member.
